(19) United States
(12) Patent Application Publication
(10) Pub. No.: US 2009/0284714 A1
(43) Pub. Date: Nov. 19, 2009

(54) PROJECTION IMAGE DISPLAY APPARATUS AND IMAGE DISPLAY SYSTEM

(75) Inventors: Yasuhide Kogo, Osaka (JP); Ippei Ohashi, Osaka (JP); Hideyuki Kanayama, Uji-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/465,896

(22) Filed: May 14, 2009

(30) Foreign Application Priority Data
May 14, 2008 (JP) 2008-127573

(51) Int. Cl. G03B 21/28

(52) U.S. Cl. 353/48; 353/98

(57) ABSTRACT

The projection image display apparatus includes an image light generator and a projection optics. The projection optics includes a reflection mirror. The projection image display apparatus includes a motion sensor configured to detect a person being close to a projection region and an image controller configured to control an image to be displayed on a projection region depending on a detection result from the motion sensor.

### CROSS REFERENCE TO RELATED APPLICATIONS

This application is based upon and claims the benefit of priority from prior Japanese Patent Application No. 2008-127573, filed on May 14, 2008; the entire contents of which are incorporated herein by reference.

### BACKGROUND OF THE INVENTION

1. Field of the Invention

The present invention relates to a projection image display apparatus having a projection optics configured to project image light and an image display system.

2. Description of the Related Art

Heretofore, there has been known a projection image display apparatus which includes an imager modulating light emitted from a light source, and a projection lens projecting light emitted from the imager on a projection surface (screen).

In order to display a magnified image on the screen, a distance between the projection lens and the screen needs to be long. To make this possible, a projection display system has been proposed that is designed to shorten a distance between a projection image display apparatus and a screen by using a reflection mirror reflecting light emitted through a projection lens, on the screen (for example, see Japanese Patent Publication No. 2006-235516 (Claim 1, FIG. 1 etc.)).

When an attempt is made to shorten the distance between the projection image display apparatus and the screen, the projection image display apparatus inevitably comes closer to the screen and consequently comes into the user's view. To avoid this, projection needs to be performed obliquely from above, below, or a side of the screen. For example, in the projection display system described above, an imager and a projection optics are shifted relative to each other in the vertical direction, and a concave mirror is used as the reflection mirror, in order to shorten the projection distance and perform the oblique projection.

Meanwhile, as a new installation/projection method of the projection image display apparatus, which is designed to shorten the projection distance, conceivable is, for example, a method of installing the projection image display apparatus on a floor or a desk and projecting an object on the floor or the desk. However, not much attention is paid to how and in what occasion such a new installation/projection method can be used.

### SUMMARY OF THE INVENTION

A projection image display apparatus according to a first aspect of the present invention includes an image light generator (image light generator 200) configured to generate image light and a projection optics (projection optics 300) configured to project the image light on a projection surface. The projection optics includes a reflection mirror (reflection mirror 320) configured to reflect the image light emitted from the image light generator. The projection image display apparatus includes an image controller (image controller 252) configured to control an image to be displayed on the projection surface depending on a detection result detected by a motion sensor (motion sensor 500) configured to detect a person being close to the projection surface.

According to the first aspect, the image controller controls an image to be displayed on the projection surface depending on the detection result detected by the motion sensor. Accordingly, in a case where there is no person viewing the image to be displayed on the projection surface, it can be suppressed that an image is to be unnecessarily displayed.

In the first aspect, the motion sensor detects movement of the person. The image controller moves a display position to display an image in the projection surface, depending on the movement of the person, which is detected by the motion sensor.

An image display system according to a second aspect includes a plurality of projection image display apparatuses which are provided along a predetermined passage in which a pedestrian passes through. Each of the plurality of the projection image display apparatuses includes an image light generator configured to generate image light and a projection optics configured to project the image light on a projection surface corresponding to each of the plurality of projection image display apparatuses. The projection optics includes a reflection mirror configured to reflect the image light emitted from the image light generator. Each of the plurality of the projection image display apparatuses includes an image controller configured to control an image to be displayed on the projection surface depending on a detection result detected by a motion sensor configured to detect the pedestrian being close to the projection surface. The image controller provided in each of the plurality of the projection image display apparatuses takes over an image to be displayed on the projection surface as the pedestrian moves.

### BRIEF DESCRIPTION OF THE DRAWINGS

FIG. 1 is a view showing a projection image display apparatus 100 according to a first embodiment of the present invention;

FIG. 2 is a view showing a cross section of the projection image display apparatus 100 according to the first embodiment;

FIG. 3 is a view showing the configuration of an image light generator 200 and a projection optics 300 according to the first embodiment;

FIG. 4 is a view showing a control unit 250 according to the first embodiment;

FIG. 5 is a view showing a display example according to the first embodiment;

FIG. 6 is a view showing an image display system according to a second embodiment;

FIG. 7 is a view showing a control unit 250A according to the second embodiment; and

FIG. 8 is a view showing a display example according to the second embodiment.

### DESCRIPTION OF THE PREFERRED EMBODIMENTS

A projection image display apparatus according to embodiments of the present invention will be described below with reference to the drawings. In the following description of the drawings, the same or similar parts will be denoted by the same or similar reference numerals.

However, it should be noted that the drawings are schematic and that proportions of dimensions and the like are different from actual ones. Thus, specific dimensions and the like should be determined by referring to the following description. Naturally, there are portions where relations or proportions of dimensions between the drawings are different.

### First Embodiment

### (Arrangement of Projection Image Display Apparatus)

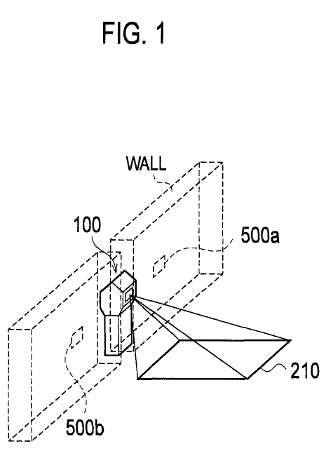

An arrangement of a projection image display apparatus according to a first embodiment of the present invention will be described below with reference to the drawings. FIG. 1 is a view showing the arrangement of a projection image display apparatus 100 according to the first embodiment. As shown in FIG. 1, the projection image display apparatus 100 is provided in a wall of a predetermined passage or the like through which a pedestrian passes. The projection image display apparatus 100 displays an image on a projection region 210 provided on a road surface of the predetermined passage or the like.

In addition, multiple motion sensors 500 (motion sensors 500a and 500b) are provided in the wall of the predetermined passage or the like.

Each of the motion sensors 500 detects a person (pedestrian) being close to the projection region 210. The detection result detected by the motion sensor 500 is transmitted to the projection image display apparatus 100.

It is preferable here that the motion sensor 500 detects movement of a person (pedestrian) passing through the predetermined passage or the like.

### (Configuration of Projection Image Display Apparatus)

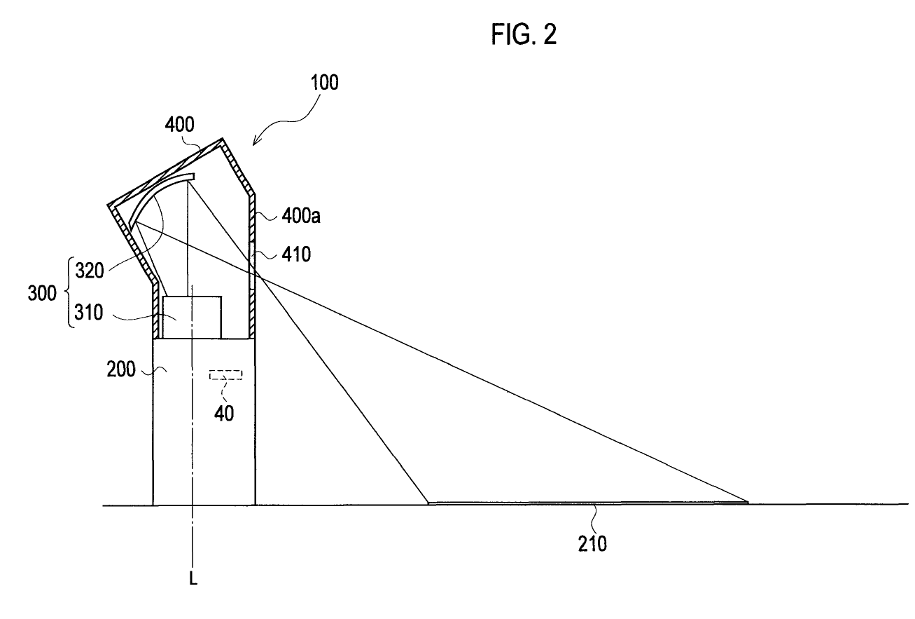

A configuration of the projection image display apparatus according to the first embodiment will be described below with reference to the drawings. FIG. 2 is a view showing the configuration of the projection image display apparatus 100 according to the first embodiment.

As shown in FIG. 2, the projection image display apparatus 100 includes a casing 400 which houses an image light generator 200 and a projection optics 300. In the first embodiment, one portion of the casing 400 constitutes a protection cover 400a.

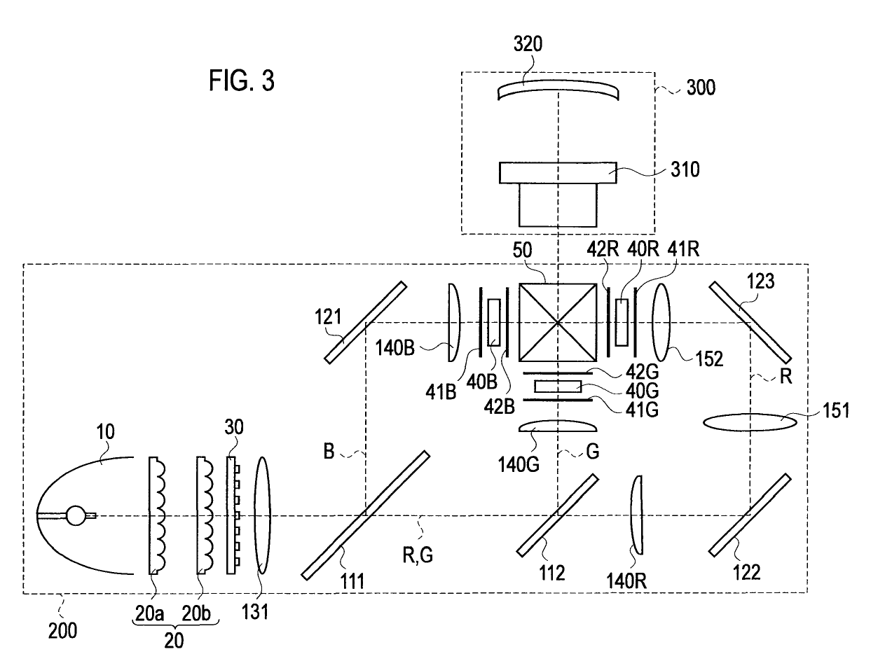

The image light generator 200 generates image light. Specifically, the image light generator 200 includes at least a display device 40 emitting the image light. The display device 40 is provided in a position shifted relative to an optical axis L of the projection optics 300. This shifted arrangement enables oblique projection. A reflective liquid crystal panel, a transmissive liquid crystal panel, a digital micromirror device (DMD), or the like can be used for the display device 40, for example. The image light generator 200 will be described in detail later (See FIG. 3).

The projection optics 300 projects image light emitted from the image light generator 200. The projection optics 300 projects the image light on the projection region 210. Specifically, the projection optics 300 includes a projection lens 310 and a reflection mirror 320.

The projection lens 310 emits image light emitted from the image light generator 200 towards the reflection mirror 320.

The reflection mirror 320 reflects the image light emitted from the projection lens 310. The reflection mirror 320 concentrates and then magnifies the image light. The reflection mirror 320 is, for example, an aspheric mirror having a concave surface on the image light generator 200 side thereof.

The protection cover 400a protects the reflection mirror 320. The protection cover 400a is provided at least in an optical path of the image light reflected by the reflection mirror 320. The protection cover 400a includes a transmission region 410 through which the image light is transmitted.

In this manner, the projection optics 300 projects the image light transmitted through the transmission region 410 on the projection region 210.

### (Configuration of Image Light Generator)

A configuration of the image light generator according to the present embodiment will be described with reference to the drawing. FIG. 3 is a view mainly showing the image light generator 200 and the projection optics 300 according to the first embodiment. The image light generator 200 includes, in addition to the configuration shown in FIG. 3, a power source circuit (not shown), an image signal processing circuit (not shown), and the like. Here, a case where the display device 40 is a transmissive liquid crystal display panel will be illustrated (hereinafter, the display device 40 will be also referred to as a liquid crystal panel 40).

The image light generator 200 includes a light source 10, a fly-eye lens unit 20, a PBS array 30, multiple liquid crystal panels 40 (liquid crystal panels 40R, 40G, and 40B), and a cross-dichroic prism 50.

The image light generator 200 includes a mirror group (dichroic mirror 111, dichroic mirror 112, reflection mirrors 121 to 123) and a lens group (a condenser lens 131, a condenser lens 140R, a condenser lens 140G, a condenser lens 140B, and relay lenses 151 and 152).

The light source 10 is, for example, an ultra-high pressure mercury lamp (UHP lamp) formed of a burner and a reflector. Light emitted from the light source 10 includes red, green and blue light components.

The fly-eye lens unit 20 equalizes the light emitted from the light source 10. In other words, the fly-eye lens unit 20 equalizes the amounts of light emitted from a central portion of the light source 10 and light emitted from a peripheral portion thereof. Specifically, the fly-eye lens unit 20 is formed of a fly-eye lens 20a and a fly-eye lens 20b.

Each of the fly-eye lenses 20a and 20b is formed of multiple microlenses. The light emitted from the light source 10 is guided by the microlenses to be incident on the whole surface of each display device 40.

The PBS array 30 aligns the polarization states of the light beams emitted from the fly-eye lens unit 20. In the first embodiment, the PBS array 30 adjusts the light beams emitted from the fly-eye lens unit 20 to P polarization.

The dichroic mirror 111 transmits the red light beam and the green light beam from among the light beams emitted from the PBS array 30. The dichroic mirror 111 reflects the blue light beam from among the light beams emitted from the PBS array 30.

The dichroic mirror 112 transmits the red light beam from among the light beams transmitted through the dichroic mirror 111. The dichroic mirror 112 reflects the green light beam transmitted through the dichroic mirror 111.

The reflection mirror 121 reflects the blue light beam to lead the blue light beam towards the liquid crystal panel 40B side. The reflection mirrors 122 and 123 reflect the red light beam to lead the red light beam towards the liquid crystal panel 40R side.

The condenser lens 131 is a lens which concentrates white light emitted from the light source 10.

The condenser lens 140R makes the red light beam a substantially parallel beam so that the red light beam can be incident on the liquid crystal panel 40R; the condenser lens 140G makes the green light beam a substantially parallel beam so that the green light beam can be incident on the liquid crystal panel 40G; the condenser lens 140B makes the blue light beam a substantially parallel beam so that the blue light beam can be incident on the liquid crystal panel 40B.

The relay lenses 151 and 152 form an approximate image of the red light beam on the liquid crystal panel 40R while suppressing expansion of the red light beam.

The liquid crystal panel 40R modulates the red light beam by rotating the polarization direction of the red light beam. On the light-incident surface side of the liquid crystal panel 40R, a light-incident-side polarizing plate 41R is provided. The light-incident-side polarizing plate 41R transmits a light beam having one polarization direction (for example, P polarization) and shields a light beam having the other polarization direction (for example, S polarization). Meanwhile, on the light-emitting surface side of the liquid crystal panel 40R, a light-emitting side polarizing plate 42R is provided. The light-emitting side polarizing plate 42R shields the light beam having one polarization direction (for example, P polarization) and transmits the light beam having the other polarization direction (for example, S polarization).

Similarly, the liquid crystal panels 40G and 40B respectively modulate the green light beam and the blue light beam by rotating the polarization directions of the green light beam and the blue light beam. On the light-incident surface side of the liquid crystal panel 40G, a light-incident-side polarizing plate 41G is provided. On the light-emitting surface side of the liquid crystal panel 40G, a light-emitting side polarization panel 42G is provided. On the light-incident surface side of the liquid crystal panel 40B, a light-incident-side polarizing plate 41B is provided. On the light-emitting surface side of the liquid crystal panel 40B, a light-emitting side polarizing plate 42B is provided.

The cross-dichroic prism 50 combines light beams emitted from the liquid crystal panels 40R, 40G, and 40B. The cross-dichroic prism 50 emits the combined light beam to the projection lens 310 side.

### (Function of Projection Image Display Apparatus)

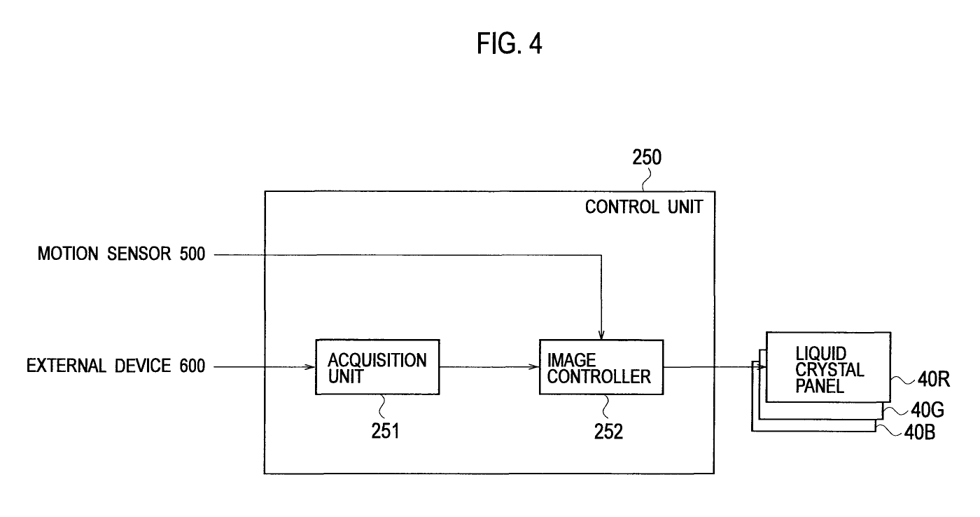

A function of the projection image display apparatus according to the first embodiment will be described below with reference to the drawing. FIG. 4 is a block diagram showing a controller 250 provided in the projection image display apparatus 100 according to the first embodiment. The controller 250 is provided in the image light generator 200.

As shown in FIG. 4, the controller 250 includes an acquisition unit 251 and an image controller 252.

The acquisition unit 251 acquires image data from an external device 600 such as DVD player. The image data is data used for displaying an image on the projection region 210. The image to be displayed on the projection region 210 includes an advertisement to pedestrians passing through the predetermined passage or the like.

The image controller 252 controls an image to be displayed on the projection region 210. That is, the image controller 252 controls display devices 40 (liquid crystal panels 40R, 40G, and 40B).

Specifically, the image controller 252 displays an image on the projection region 210 by using the image data acquired by the acquisition unit 251 depending on the detection result detected by the motion sensor 500. That is, the image controller 252 displays an image on the projection region 210 when a person (pedestrian) comes closer to the projection region 210.

It is preferable here that the image controller 252 move a display position where an image is displayed in the projection region 210 depending on the movement of the person (pedestrian) detected by the motion sensor 500.

Furthermore, it is preferable that the image controller 252 changes a moving speed of the display position in accordance with a moving speed of the person (pedestrian). For example, the image controller 252 increases the moving speed of the display position when the moving speed of the person (pedestrian) is fast.

### (Image Display Example)

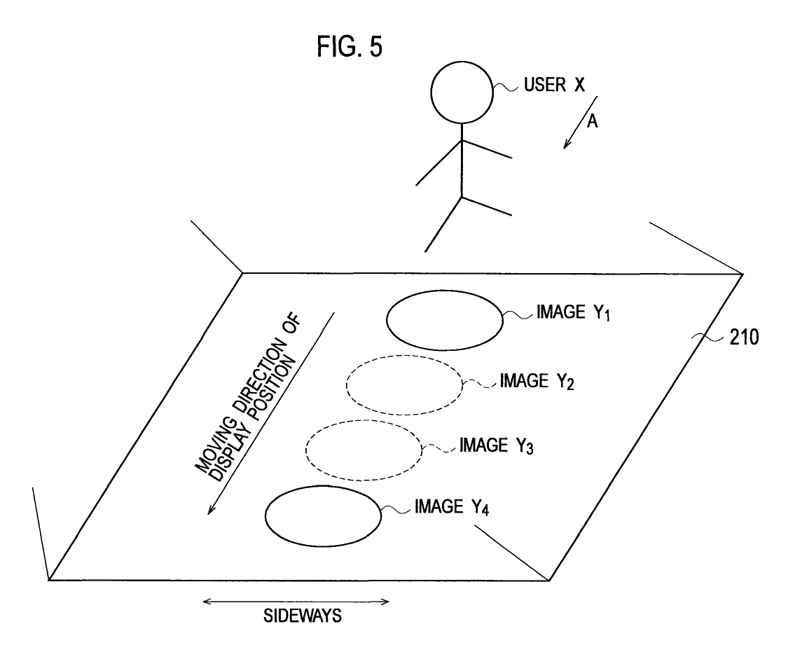

An image display example according to the first embodiment will be described below with reference to the drawing. FIG. 5 is a view showing an image display example according to the first embodiment. In FIG. 5, a case where a user X moves in the direction A is considered.

Firstly, when the user X comes close to the projection region 210, the projection image display apparatus 100 displays an image Y (image Y₁) on the projection region 210. Subsequently, the projection image display apparatus 100 moves the display position of the image Y from the position of the image Y₁ to that of an image Y₄ along the moving direction (direction A) of the user X, in the projection region 210.

If the user moves sideways, it is preferable that the projection image display apparatus 100 move the display position sideways so as to follow the movement of the user X.

### (Advantages and Effects)

In the first embodiment, the image controller 252 controls an image to be displayed on the projection region 210 depending on the detection result detected by the motion sensor 500. Specifically, the image controller 252 displays an image on the projection region 210 when a person comes close to the projection region 210. Accordingly, in a case where there is no person viewing the image displayed on the projection region 210, it can be suppressed that the image is unnecessarily displayed.

In addition, the image controller 252 moves the display position where an image is displayed in the projection region 210 depending on the movement of the person. Accordingly, the moving person can easily see the image to be displayed on the projection region 210.

### Second Embodiment

A second embodiment of the present invention will be described below with reference to the drawings. In the following description, differences between the first embodiment and the second embodiment will be mainly described.

In the second embodiment, an image display system includes multiple projection image display apparatuses which are provided along a predetermined passage. An image to be displayed on a projection region by one of the multiple projection image display apparatuses is taken over to the next, as a person (pedestrian) moves.

### (Configuration of Image Display System)

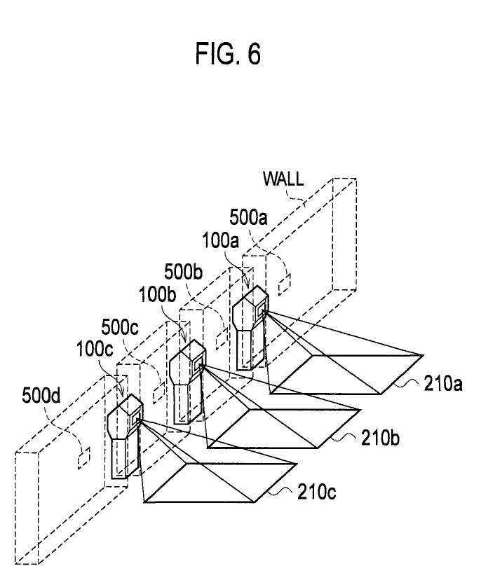

A configuration of an image display system according to the second embodiment will be described below with reference to the drawing. FIG. 6 is a view showing the image display system according to the second embodiment.

As shown in FIG. 6, the image display system includes multiple projection image display apparatuses 100 (projection image display apparatuses 100a to 100c) which are provided along a predetermined passage.

Similar to the first embodiment, each of the projection image display apparatuses 100 is provided in a wall of the predetermined passage or the like through which a pedestrian passes. The projection image display apparatuses 100 each displays an image on corresponding one of projection regions 210 (projection regions 210a to 210c) provided on a road surface of the predetermined passage or the like. The projection image display apparatuses 100 are connected via a network such as a LAN.

Similar to the first embodiment, multiple motion sensors 500 (motion sensors 500a to 500d) are provided in a wall of the predetermined passage or the like.

### (Function of Projection Image Display Apparatus)

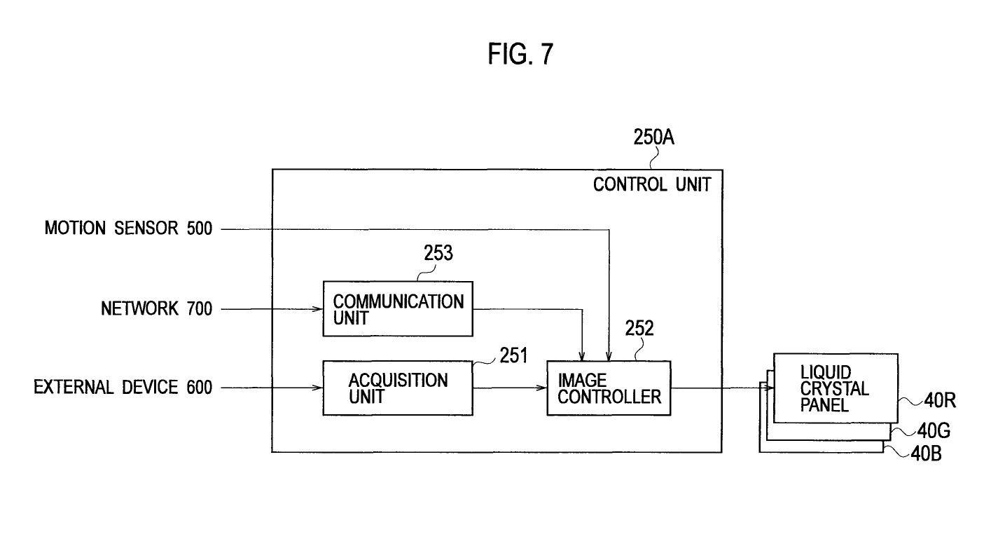

A function of the projection image display apparatus according to the second embodiment will be described below with reference to the drawing. FIG. 7 is a block diagram showing a control unit 250A provided in the projection image display apparatus 100 according to the second embodiment. The control unit 250A is provided in an image light generator 200. In FIG. 7, the same components as those in FIG. 4 are denoted by the same reference numerals.

As shown in FIG. 7, the control unit 250A includes a communication unit 253 in addition to the configuration shown in FIG. 4. The communication unit 253 is connected to a network 700. The communication unit 253 acquires a state of image to be displayed on the projection region 210 by a different projection image display apparatuses 100. The state of image includes a content of image and a progress in displaying the image. The different projection image display apparatuses 100 is the projection image display apparatuses 100 adjacent to the projection image display apparatus 100 in the approaching direction of the user.

The above-described image controller 252 takes over the image to be displayed on the projection region 210 from the different projection image display apparatus 100 on the basis of the state of image acquired by the communication unit 253.

Specifically, when a person being close to the projection region 210 of the projection image display apparatus 100 including the image controller 252 is detected, the image controller 252 specifies the content of image which is the same as that of the different projection image display apparatus 100. Additionally, the image controller 252 specifies the progress in displaying the image to be displayed by the different projection image display apparatus 100. Subsequently, the image controller 252 displays an image from the continuation of the image displayed by the different projection image display apparatus 100, on the projection region 210 corresponding to the projection image display apparatus 100 including the image controller 252.

### (Image Display Example)

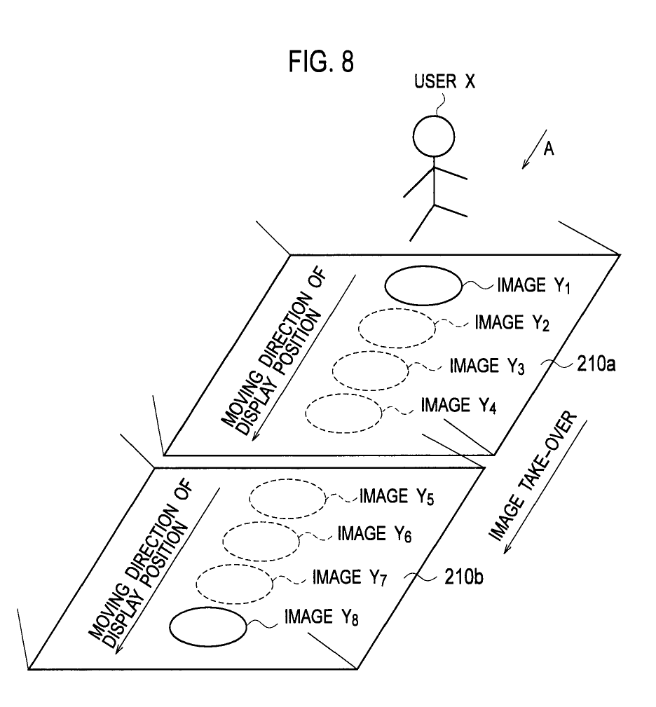

An image display example according to the second embodiment will be described with reference to the drawing. FIG. 8 is a view showing an image display example according to the second embodiment. In FIG. 8, a case where a user X moves in the direction A is considered.

Firstly, when the user X comes close to a projection region 210a, a projection image display apparatus 100a displays an image Y (image Y₁) on the projection region 210a. Subsequently, the projection image display apparatus 100a moves a display position of the image Y from the position of the image Y₁ to that of an image Y₄ along the moving direction (direction A) of the user X, in a projection region 210b.

Secondly, when the user X comes close to the projection region 210b, a projection image display apparatus 100b displays an image Y (image Y₅) on the projection region 210b. Here, the projection image display apparatus 100b displays the image Y from the continuation of the image Y₄. Subsequently, the projection image display apparatus 100b moves a display position of the image Y from the position of the image Y₅ to that of an image Y₈ along the moving direction (direction A) of the user X, in the projection region 210b.

### (Advantages and Effects)

In the second embodiment, each projection image display apparatus takes over an image to be displayed on the projection region as a person (pedestrian) moves. Accordingly, the images to be displayed by the multiple projection image display apparatuses 100 can obtain a stream of images.

### Other Embodiments

The present invention has been described by the above-described embodiments. However, it should be understood that the description and drawings constituting one part of this disclosure do not limit the present invention. Various alternative embodiments, examples, and operational techniques will be apparent from this disclosure for those skilled in the art.

While not particularly described in the above embodiments, the projection cover 400a may have an opening communicating with the projection region 210 side from the reflection mirror 320. The transmission region 410 may be such an opening.

While not particularly described in the above embodiments, at least one portion of the protection cover 400a may be formed of a light transmissive member such as a transparent resin or glass. The transmission region 410 may be formed of such a light transmissive member.

While not particularly described in the above embodiments, it is preferable that the transmission region 410 be provided in a vicinity of a position in which image light is concentrated by the reflection mirror 320. With this configuration, the transmission region 410 may be reduced in size. Accordingly, for example, if the transmission region 410 is an opening, dusts can hardly enter inside the projection cover 400a, or if the transmission region 410 is formed of a light transmissive member, the light transmissive member is hardly damaged.

In the above-described embodiments, the description has been given of the case where an aspherical mirror is used as the reflection mirror 320. However, the reflection mirror 320 is not limited to this. For example, a free-form surface mirror may be used as the reflection mirror 320. In addition, if any efforts are made in adjusting an aberration or a resolution, a spherical mirror may be used as the reflection mirror 320.

In the above-described embodiments, the description has been given of the case where the multiple display devices 40 are used as the configuration of the image light generator 200 (three-plate-type). However, the configuration of the image light generator 200 is not limited to this. As the configuration of the image light generator 200, a single display device 40 may be used (single-plate-type).

In the above-described embodiments, the projection image display apparatus 100 is provided in the wall of the predetermined passage. However, the arrangement of the projection image display apparatus 100 is not limited to this. The projection image display apparatus 100 may be provided on a ceiling or a floor.

In the above-described embodiments, the projection region 210 is provided on a floor surface of the predetermined passage. However, the position of the projection region 210 is not limited to this. The projection region 210 may be provided on a wall surface or a ceiling surface.

In the above-described embodiments, the description is merely exemplified of the case where the projection image display apparatus 100 is provided in the predetermined passage. However, the projection image display apparatus 100 can be installed in various places such as a restroom in a facility like a hotel, a garden, a museum, a botanical garden, and a zoo.

In the above-described embodiments, the motion sensor 500 is provided in a wall of the predetermined passage or the like. The arrangement of the motion sensor 500 is not limited to this. Specifically, the motion sensor 500 may be provided in the projection image display apparatus 100. Additionally, the motion sensor 500 may be provided on a floor or a ceiling.

While not particularly described in the aforementioned second embodiment, the communication unit 253 may acquire the state of image to be displayed by the different projection image display apparatuses 100, directly from the different projection image display apparatuses 100. Additionally, the communication unit 253 may acquire the state of image to be displayed by the different projection image display apparatuses 100, from a management sever. Note that the management server manages the states of images to be displayed by the multiple projection image display apparatuses 100.

According to the above embodiments, the distance between the projection image display apparatus 100 and the projection surface 210 is shortened by providing the reflection mirror 320. This makes it possible: to prevent image light from being blocked by a person or thing coming between the projection image display apparatus 100 and the projection surface 210; and to reduce the possibility of irradiating a person with laser light (image light) when LD is used for the light source 10.

What is claimed is:

1. A projection image display apparatus comprising:
an image light generator configured to generate image light;
a projection optics configured to project the image light on a projection surface, the projection optics having a reflection mirror configured to reflect the image light emitted from the image light generator; and
an image controller configured to control an image to be displayed on the projection surface depending on a detection result from a motion sensor configured to detect a person being close to the projection surface.

2. The projection image display apparatus according to claim 1, wherein
the motion sensor detects movement of the person, and
the image controller moves a display position where an image is displayed in the projection surface, depending on the movement of the person detected by the motion sensor.

3. An image display system comprising a plurality of projection image display apparatuses provided along a predetermined passage where a pedestrian passes through, wherein
each of the plurality of projection image display apparatuses includes an image optical generator configured to generate image light and a projection optics configured to project the image light on a projection surface corresponding to each of the plurality of projection image display apparatuses,
the projection optics includes a reflection mirror configured to reflect the image light emitted from the image light generator,
each of the plurality of projection image display apparatuses includes an image controller configured to control an image to be displayed on the projection surface depending on a detection result from a motion sensor configured to detect the pedestrian being close to the projection surface, and
the image controller provided in each of the plurality of projection image display apparatuses takes over an image to be displayed on the projection surface as the pedestrian moves.
